(19) United States
(12) Patent Application Publication
(10) Pub. No.: US 2019/0006643 A1
(43) Pub. Date: Jan. 3, 2019

(54) BATTERY MODULE

(71) Applicant: HONDA MOTOR CO., LTD., Tokyo (JP)

(72) Inventor: Atsushi SAKURAI, Saitama (JP)

(73) Assignee: HONDA MOTOR CO., LTD., Tokyo (JP)

(21) Appl. No.: 15/984,917

(22) Filed: May 21, 2018

(30) Foreign Application Priority Data
Jun. 28, 2017 (JP) 2017-126432

(51) Int. Cl. H01M 2/10; H01M 10/48

(52) U.S. Cl. CPC H01M 2/1077; H01M 2220/20; H01M 10/482; H01M 10/486

(57) ABSTRACT

A battery module includes: a cell stack body a pair of end plates disposed on a front surface and a rear surface of the cell stack body; and a fastening frame for connecting the pair of end plates. The fastening frame includes a right side frame, a left side frame, and a lower frame. The right side frame and the left side frame each includes a lower flange portion extending in a direction coming closer to each other along the lower surface of the cell stack body. The lower frame is disposed between the lower surface of the cell stack body and the lower flange portions of the left side frame and the right side frame. The lower frame includes a fixing portion fixed to a structure for supporting the battery module.

### CROSS-REFERENCE TO RELATED APPLICATION(S)

This application claims priority from Japanese Patent Application No. 2017-126432 filed on Jun. 28, 2017, the entire contents of which are incorporated herein by reference.

### FIELD

The present invention relates to a battery module mounted on an electric vehicle.

### BACKGROUND

A battery module has been mounted on an electric vehicle or the like. For example, a battery module is disclosed in JP-A-2012-256466 which is formed by a plurality of cells stacked in a front-rear direction and includes a cell stack body having a front surface, a rear surface, a left surface, a right surface, an upper surface, and a lower surface, a pair of end plates disposed on the front surface and the rear surface of the cell stack body, and a fastening frame for connecting the pair of end plates.

In this type of battery module, a load in a cell stacking direction of the battery module (hereinafter, appropriately referred to as a cell thickness constraint reaction force) occurs due to expansion of the cell caused by temperature change and aging deterioration. In recent years, since more active material is packed in the cell in accordance with the high capacity and the high energy density of the cell, the cell thickness constraint reaction force tends to increase and dimensional variation between the end plates due to variation of the cell thickness constraint reaction force is inevitable.

In the battery module disclosed in JP-A-2012-256466, however, since the fixing portion fixed to the structure for supporting the battery module is provided on the end plate, the cell thickness constraint reaction force may increase due to the expansion of the cell caused by temperature change and aging deterioration, and accordingly a large stress may be transferred to the structure when the end plate moves.

### SUMMARY

The present invention is to provide a battery module capable of avoiding stress transfer to a structure for supporting the battery module.

The invention provides following aspects (1) to (11),

(1) A battery module (e.g., a battery module 1 in an embodiment) including:

a cell stack body (e.g., a cell stack body 2 in an embodiment) that is constituted by a plurality of cells (e.g., cells 21 in an embodiment) stacked in a front-rear direction and includes a front surface, a rear surface, a left surface, a right surface, an upper surface, and a lower surface;

a pair of end plates (e.g., end plates 3 in an embodiment) that are disposed on the front surface and the rear surface of the cell stack body; and

a fastening frame (e.g., a fastening frame 4 in an embodiment) that connects the pair of end plates, wherein

the fastening frame includes:

a right side frame (e.g., a right side frame 5R in an embodiment) disposed on the right surface of the cell stack body;

a left side frame (e.g., a left side frame 5L in an embodiment) disposed on the left surface of the cell stack body; and

a lower frame (e.g., a lower frame 6 in an embodiment) disposed on the lower surface of the cell stack body,

the right side frame and the left side frame each includes a lower flange portion (e.g., lower flange portions 54 in an embodiment) extending in a direction coming closer to each other along the lower surface of the cell stack body,

the lower frame is disposed between the lower surface of the cell stack body and the lower flange portions of the left side frame and the right side frame, and

the lower frame includes fixing portions (e.g., a fixing portion 62 in an embodiment) that are fixed to a structure for supporting the battery module.

(2) The battery module according to (1), wherein

the pair of end plates each includes:

a left end plate portion (e.g., a left end plate portion 32L in an embodiment);

a right end plate portion (e.g., a right end plate portion 32R in an embodiment), and

a central end plate portion (e.g., a central end plate portion 31 in an embodiment) interposed between the left end plate portion and the right end plate portion in a left-right direction,

a width (e.g., a width W1 in an embodiment) of the central end plate portion in the front-rear direction is larger than a width (e.g., a width W2 in an embodiment) of the left end plate portion and the right end plate portion in the front-rear direction, and

the fixing portions are disposed at overlapping positions with the left end plate portion and the right end plate portion in the left-right direction.

(3) The battery module according to (1), wherein

the pair of end plates each includes a hollow portion (e.g., a hollow portion 33 in an embodiment) that penetrates in an up-down direction, and

the fixing portions are disposed at overlapping positions with the hollow portions as viewed in the up-down direction.

(4) The battery module according to (1), wherein

the lower frame includes:

a lower frame body (e.g., a lower frame body 61 in an embodiment) extending along the lower surface of the cell stack body; and

guide portions (e.g., a guide portion 63) protruding upward from left and right ends of the lower frame body and extending in the front-rear direction.

(5) The battery module according to any one of (1) to (4), wherein

the lower frame includes:

a lower frame body (e.g., the lower frame body 61 in an embodiment) extending along the lower surface of the cell stack body and

a fin (e.g., a fin 65 in an embodiment) protruding downward from a rear surface of the lower frame body.

(6) The battery module according to any one of (1) to (4), wherein

a thermostat (e.g., a thermostat 7 in an embodiment) is disposed below the lower frame.

(7) The battery module according to (6), wherein

the lower frame includes:

a lower frame body (e.g., the lower frame body 61 in an embodiment) extending along the lower surface of the cell stack body; and

a thermostat accommodating portion (e.g., a thermostat accommodating portion 64 in an embodiment) recessed on a rear surface of the lower frame body, and

the thermostat is disposed in the thermostat accommodating portion.

(8) The battery module according to any one of (1) to (7), wherein

the right side frame and the left side frame each includes an upper flange portion (e.g., upper flange portions 53 in an embodiment) extending in a direction coming closer to each other along the upper surface of the cell stack body, and

the cell stack body and the lower frame are sandwiched by the upper flange portions of the right side frame and the left side frame and the lower flange portions of the right side frame and the left side frame.

(9) The battery module according to (8), wherein

the upper flange portions have elasticity.

(10) The battery module according to any one of (1) to (9), wherein

the right side frame includes a side frame body (e.g., a side frame body 51 in an embodiment) extending along the right surface of the cell stack body,

the left side frame includes a side frame body (e.g., a side frame body 51 in an embodiment) extending along the left surface of the cell stack body, and

the side frame bodies of the right side frame and the left side frame each is provided with a projection (e.g., a projection 51 a in an embodiment) extending in the up-down direction between the cells adjacent to each other.

(11) The battery module according to any one of (1) to (10), wherein

the lower flange portions of the right side frame and the left side frame each is provided with a fastening portion (e.g., a fastening portion 54 a in an embodiment) for fastening the lower frame with a bolt,

the fastening portion provided in the lower flange portion of the right side frame is a leftwardly opened notch portion, and

the fastening portion provided in the lower flange portion of the left side frame is a rightwardly opened notch portion.

According to (1), since the lower frame is fixed to the structure for supporting the battery module, even when the load in the cell stacking direction of the battery module increases due to the expansion of the cell caused by the temperature change and the aging deterioration, and accordingly the end plate moves, the stress transfer to the structure can be avoided.

Since the lower surface of the cell stack body is close to the lower frame, heat of the cell stack body is radiated through the lower frame.

According to (2), since the fixing portions of the lower frame are disposed at the overlapping positions in the left-right direction with the left end plate portion and the right end plate portion having a smaller width in the front-rear direction, the length of the lower frame provided with the fixing portions can be shortened, and the length in the front-rear direction of the battery module can be shortened.

According to (3), since the fixing portions are disposed at the overlapping positions with the hollow portions provided in the pair of end plates, it is not necessary to lengthen the lower frame in order to provide the fixing portions, and the length in the front-rear direction of the battery module can he shortened.

According to (4), since the lower frame is provided with the guide portions protruding upward from both left and right ends of the lower frame body and extending in the front-rear direction, the deviation in the left-right direction s regulated by the guide portions when the cell stack body vibrates.

According to (5), since the lower frame includes the fin protruding downward from the rear surface of the lower frame body, heat of the cell stack body is efficiently radiated through the lower frame.

According to (6), since the thermostat is disposed below the lower frame, the temperature of the cell stack body can be controlled by the thermostat.

According to (7), since the lower frame is provided with the thermostat accommodating portion recessed on the rear surface of the lower frame body and the thermostat is disposed in the thermostat accommodating portion, the length in the up-down direction of the battery module can be shortened.

According to (8), since the cell stack body and the lower frame are sandwiched between the upper flange portion and the lower flange portion of the right side frame and the left side frame, the relative position variation in the up-down direction is regulated even when the load is applied to the lower frame in the up-down direction. For this reason, the load applied to the terminal of each cell and the busbar for connecting the cells to each other is reduced.

According to (9), since the upper flange portion has elasticity, when the right side frame and the left side frame are easily attached in the left-right direction due to the elastic deformation of the upper flange portion.

According to (10), since the side frame bodies of the right side frame and the left side frame each is provided with a projection extending in the up-down direction between the cells adjacent to each other, vibration in the front-rear direction of the cell is prevented.

According to (11), since the fastening portion provided in the lower flange portion of the right side frame is the leftwardly opened notch portion and the fastening portion provided in the lower flange portion of the left side frame is the rightwardly opened notch portion, the right side frame and the left side frame can he mounted in the left-right direction in the state where the bolt is temporarily fixed to the lower frame.

### BRIEF DESCRIPTION OF DRAWINGS

FIG. 1 is a perspective view of a battery module according to a first embodiment of the present invention as viewed obliquely from above.

FIG. 2 is a perspective view of the battery module according to the first embodiment of the present invention as viewed obliquely from below.

FIG. 3 is an exploded perspective view of the battery module according to the first embodiment of the present invention.

FIG. 4 is a cross-sectional view taken along line A-A in FIG. 2.

FIG. 5 is a plan view illustrating a main part of the battery module according to the first embodiment of the present invention.

FIG. 6 is a perspective view of a battery module according to a second embodiment of the present invention as viewed obliquely from below.

FIG. 7 is a cross-sectional view taken along line B-B in FIG. 6.

FIG. 8 is a plan view illustrating a main part of a battery module according to a third embodiment of the present invention.

FIG. 9 is a cross-sectional view taken along line C-C in FIG. 8.

FIG. 10 is a plan view illustrating a main part of a battery module according to a fourth embodiment of the present invention.

### DETAILED DESCRIPTION

Battery modules according to embodiments of the present invention will be described with reference to the accompanying drawings. It is noted that the drawings are to be viewed in directions of reference numerals.

### First Embodiment

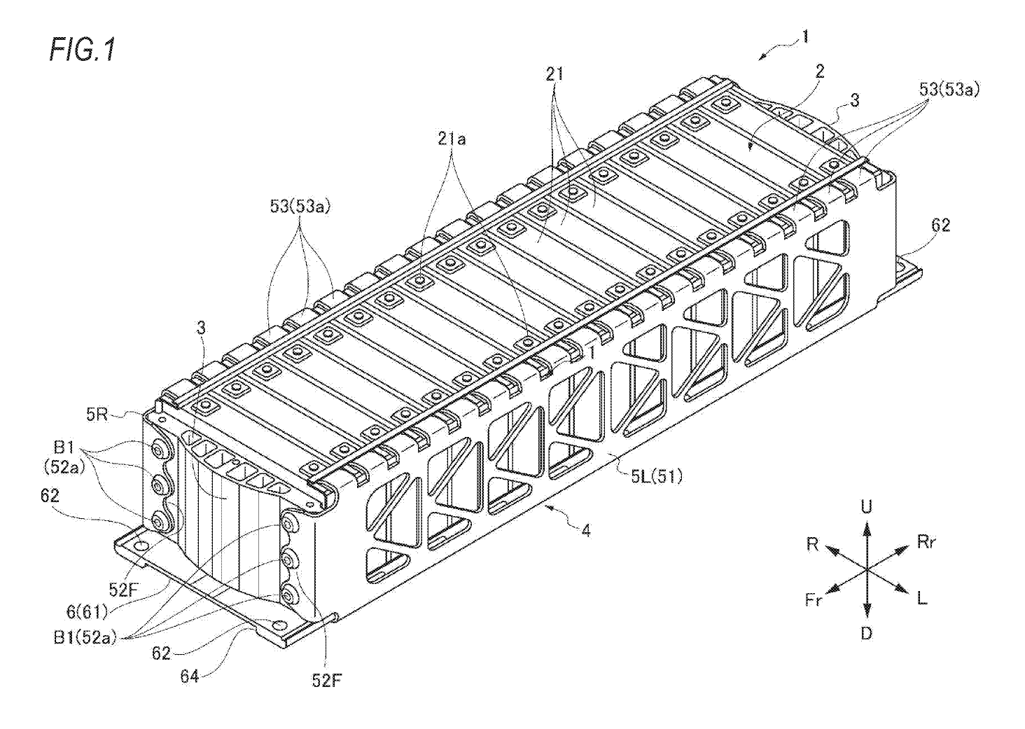

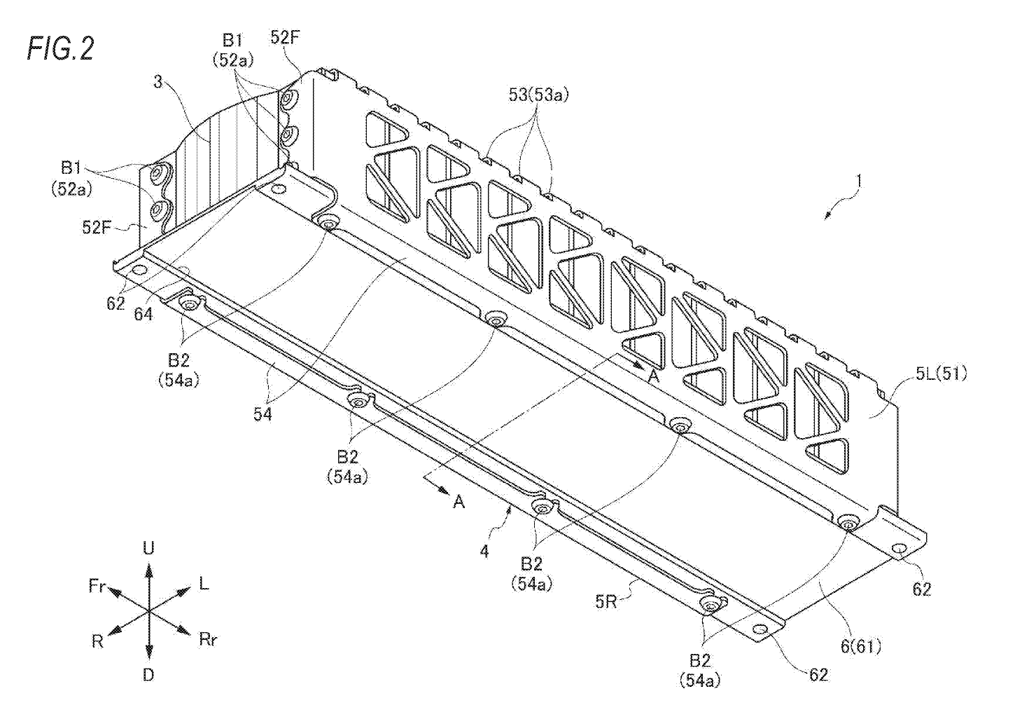

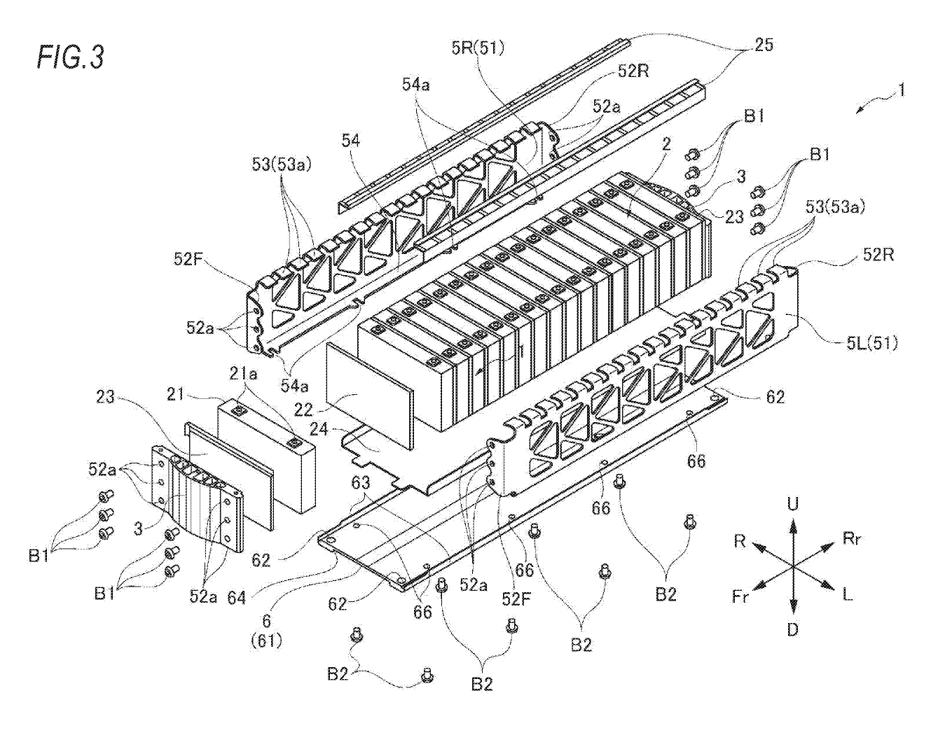

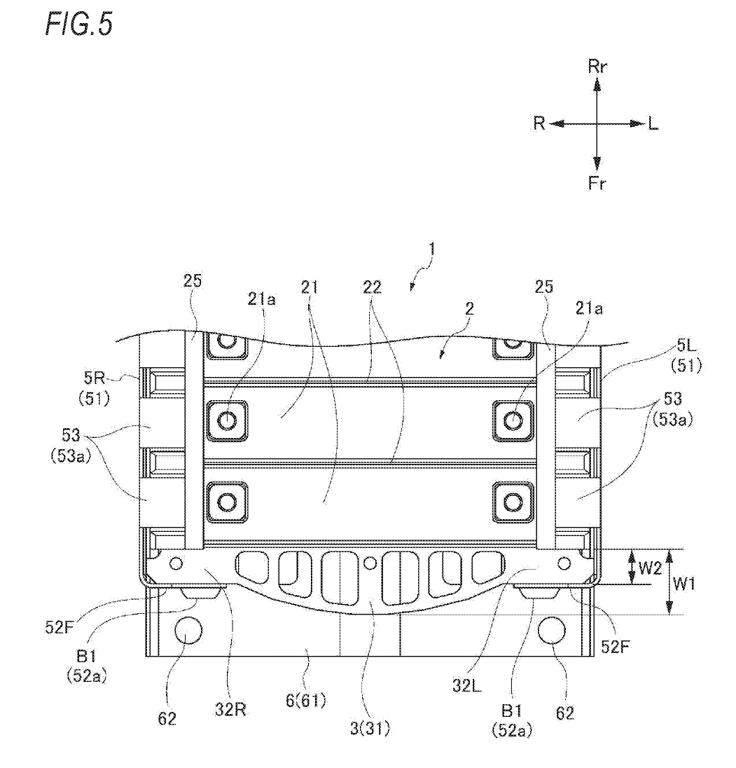

As illustrated in FIGS. 1 to 5, a battery module 1 according to a first embodiment of the present invention is constituted by a cell stack body 2 in which a plurality of cells 21 are stacked in a front-rear direction, and which includes a front surface, a rear surface, a left surface, a right surface, an upper surface, and a lower surface, a pair of end plates 3 disposed on the front and rear surfaces of the cell stack body 2, and a fastening frame 4 for connecting the pair of end plates 3. The fastening frame 4 includes a right side frame SR disposed on the right surface of the cell stack body 2, a left side frame 5L disposed on the left surface of the cell stack body 2, and a lower frame 6 disposed on the lower surface of the cell stack body 2.

For the simple and clear description in this specification, a stacking direction of the cells 21 is defined as a front-rear direction, a direction orthogonal to the stacking direction of the cells 21 is defined as a left-right direction and an up-down direction. The stacking direction is irrelevant to a front-rear direction or the like of products on which a battery module 1 is mounted. That is, when the battery module 1 is mounted on a vehicle, the stacking direction of the cells 21 may be aligned with a front-rear direction of the vehicle, may be an up-down direction and a left-right direction of the vehicle, or may be inclined with respect to these directions. In the drawings, a front side, a rear side, a left side, a right side, an upper side, and a lower side of the battery module 1 are indicated by Fr, Rr, L, R, U, and D, respectively.

### (Cell Stack Body)

The cell stack body 2 is formed by a plurality of cells 21 and a plurality of first insulation member 22 which are alternately stacked in the front-rear direction.

The pair of end plates 3 are respectively disposed on the front and rear surfaces of the cell stack body 2 in an insulation state via a second insulation member 23, and the lower frame 6 is disposed on the lower surface of the cell stack body 2 in an insulation state via a third insulation member 24. In addition, the right side frame 5R and the left side frame 5L are disposed on the left and right surfaces of the cell stack body 2 in an insulation state via a slight gap therebetween. A pair of fourth insulation members 25 are disposed at a left end and a right end on the upper surface of the cell stack body 2.

It is known that the cell 21 expands due to temperature change or aging deterioration. The cell 21 has a rectangular parallelepiped shape in which a length in the up-down direction is longer than a length in the front-rear direction and a length in the left-right direction is longer than a length in the up-down direction. Therefore, the front surface and the rear surface of the cell 21 have a much larger area than the left surface, the right surface, the upper surface, and the lower surface, and the front surface and the rear surface of the cell 21 easily expand at a central part in the left-right direction and a central part in the up-down direction thereof.

A plurality of busbars (not illustrated) are disposed on the upper surface of the cell stack body 2 to be electrically connected to terminals 21a of the cells 2. As the busbars, there are busbars for connecting the terminals 21a of the cells 21 with each other or busbars for connecting the terminals 21a of the cells 21 with external connection terminals (not illustrated). When a load is applied from the battery module 1 to the busbars, connection failure may occur based on a relative position deviation between the busbar and the terminals. Therefore, the load applied to the busbars from the battery module 1 is desirably small as much as possible.

### (End Plate)

The pair of end plates 3 respectively contact with the front surface and the rear surface of the cell stack body 2 through the second insulation member 23, and receive a load in the cell stacking direction of the cell stack body 2 (hereinafter, also referred to as a cell thickness constraint reaction force as appropriate). The load in the cell stacking direction of the cell stack body 2 is mainly caused by expansion of the cells 21 due to temperature change or aging deterioration, and since the front surface and the rear surface of the cell 21 easily expand at the central part in the left-right direction and the central part in the up-down direction thereof as described above, a large load is applied to a central part in the left-right direction and a central part in the up-down direction of the end plate 3.

The end plate 3 is formed using an aluminum extrusion member and includes a central end plate portion 31 formed in a central region in the left-right direction and a left end plate portion 32L and a right end plate portion 32R formed in the left-right direction with the central end plate portion 31 interposed therebetween. As described above, the central end plate portion 31, to which the large load is applied in the cell stacking direction from the cell stack body 2, has a larger width W1 in the front-rear direction than a width W2 in the front-rear direction of the left end plate portion 32L and the right end plate portion 32R. Therefore, an inner surface of the end plate 3 in contact with the cell stack body 2 is flat, whereas an outer surface not in contact with the cell stack body 2 has a shape in which the central end plate portion 31 bulges outwards.

### (Side Frame)

The left side frame 5L and the right side frame 5R are formed by press working of a metal plate, and include side frame bodies 51 provided along the left surface or the right surface of the cell stack body 2, front flange portions 52F extending in a direction coming closer to each other along the front surface of the front-side end plate 3 from the front end of the side frame body 51, rear flange portions 52R extending in a direction coming closer to each other along the rear surface of the rear-side end plate 3 from the rear end of the side frame body 51, upper flange portions 53 extending in a direction coming closer to each other along the upper surface of the cell stack body 2 from the upper end of the side frame body 51, and lower flange portions 54 extending in a direction coming closer to each other along the lower surface of the cell stack body 2 (lower frame 6) from the lower end of the side frame body 51.

The front flange portion 52F and the rear flange portion 52R are provided with a plurality of fastening portions 52a that are fastened to the front-side end plate 3 or the rear-side end plate 3 through bolts B1. The fastening portion 52a includes a round hole into which the bolt B1 is inserted, and the front flange portion 52F and the rear flange portion 52R are fastened to the front-side end plate 3 or the rear-side end plate 3 when the bolt B1 inserted into the round hole is screwed to the front-side end plate 3 or the rear-side end plate 3. Thus, the pair of end plates 3 are connected to each other through the left side frame 5L and the right side frame 5R; however, in recent years, since the cell thickness constraint reaction force tends to increase along with the high capacity and the high energy density of the cell 21, dimensional variation between the end plates 3 due to variation of the cell thickness constraint reaction force is inevitable.

The upper flange portion 53 and the lower flange portion 54 sandwich the fourth insulation member 25, the cell stack body 2, and the lower frame 6 in the up-down direction at the left and right ends of the cell stack body 2. Thus, since a relative position variation in the up-down direction of the cell stack body 2, the fourth insulation member 25, the left side frame 5L, the right side frame 5R, and the lower frame 6 is regulated, even when the load is applied to the lower frame 6 in the up-down direction, the load applied to the terminal 21a of each cell 21 and the busbar for connecting the cells 21 to each other is reduced.

The upper flange portion 53 has elasticity, and is elastically deformed in the up-down direction. Thus, when the right side frame 5R and the left side frame 5L are easily attached to the cell stack body 2 and the lower frame 6 in the left-right direction due to the elastic deformation of the upper flange portion 53.

The upper flange portion 53 of the present embodiment includes a plurality of elastic pieces 53a aligned in the front-rear direction, and the number and position of the elastic pieces 53a are determined according to the number and position of the cells 21 stacked in the front-rear direction. Thus, the upper flange portion 53 can elastically hold the respective cells 21 with appropriate elasticity.

In the right side frame 5R and the left side frame 5L of the present embodiment, the upper flange portion 53 is press-formed integrally with the side frame body 51. However, after being press-formed separately from the side frame body 51, the upper flange portion 53 may be formed integrally with the side frame body 51 by welding or caulking.

The lower flange portion 54 is provided with a plurality of fastening portions 54a that is fastened to the lower frame 6 through bolts B2. Thus, the left side frame 5L, the right side frame 5R, and the lower frame 6 constituting the fastening frame 4 are integrally connected.

The fastening portion 54a provided in the lower flange portion 54 of the right side frame 5R is a leftwardly opened notch portion, and the fastening portion 54a provided in the lower flange portion 54 of the left side frame 5L is a rightwardly opened notch portion. Thus, the right side frame 5R and the left side frame 5L can be mounted in the left-right direction in a state where the bolt B2 is temporarily fixed to the lower frame 6.

### (Lower Frame)

The lower frame 6 is formed using an aluminum extrusion member, and includes a lower frame body 61 extending along the lower surface of the cell stack body 2 and the end plate 3, a plurality of fixing portions 62 fixed to a module supporting structure (not illustrated) for supporting the battery module 1, a pair of guide portions 63 protruding upward from left and right ends of the lower frame body and extending in the front-rear direction, a thermostat accommodating portion 64 recessed on a lower surface of the lower frame body 61, and a through hole 66 through which the bolt B2 fastened to the fastening portion 54a of the lower flange portion 54 penetrates.

The fixing portions 62 are provided at four corners of the lower frame body 61 having a rectangular shape in plan view, and are fixed to the module supporting structure through the fixing members such as bolts. According to such a fixing structure of the battery module 1, since the lower frame 6 is fixed to the module supporting structure, even when the cell pressure constraint reaction force increases due to the expansion of the cell 21 caused by the temperature change and the aging deterioration, and accordingly the end plate 3 moves in the front-rear direction, stress transfer to the module supporting structure can be avoided.

In the present embodiment, when the fixing portions 62 of the lower frame 6 are disposed on the front side of the front-side end plate 3 and the rear side of the rear-side end plate 3, the fixing portions 2 of the lower frame 6 are disposed at overlapping positions in the left-right direction with the left end plate portion 32L and the right end plate portion 32R having the width in the front-rear direction smaller than that of the central end plate portion 31. Thereby, the length of the lower frame 6 provided with the fixing portions 62 can be shortened, and the length in the front-rear direction of the battery module 1 can be shortened.

The guide portions 63 protrude upward from both left and right ends of the lower frame body 61 so as to extend along left and right side surfaces of the cell stack body 2, and extend in the front-rear direction. Thus, the deviation in the left-right direction is regulated by the guide portions 63 when the cell stack body 2 vibrates.

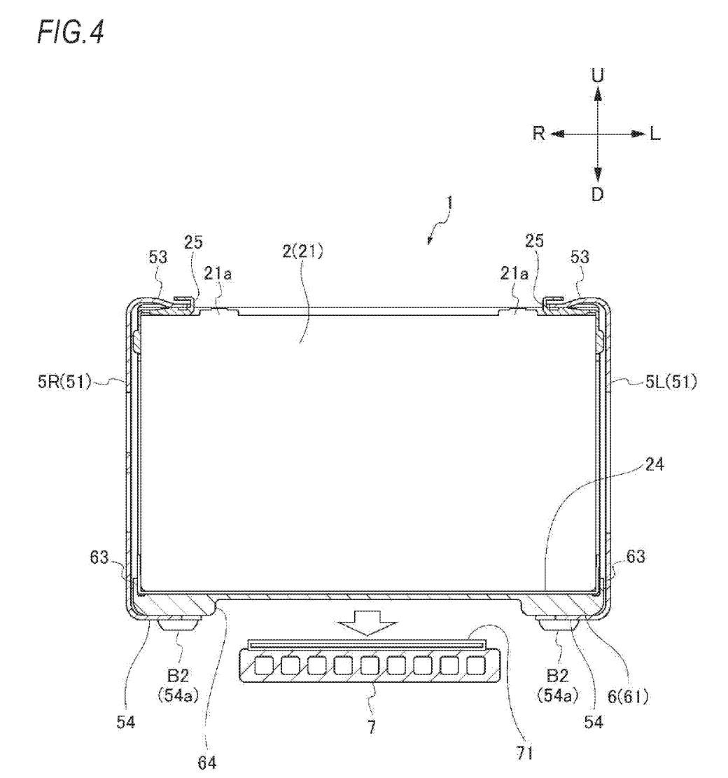

The lower frame body 61 is formed using an aluminum extrusion member, and is disposed close to the lower surface of the cell stack body 2, thereby functioning as a heat radiating member that transfers heat of the cell stack body 2 to radiate the heat. In addition, as illustrated in FIG. 4, when a thermostat 7 is disposed below the lower frame body 61, a temperature of the cell stack body 2 can be controlled by the thermostat 7. In the present embodiment, for example, a liquid-cooling heat sink, which is the thermostat 7, is disposed on the lower surface of the lower frame body 61 through a plastic heat transfer member 71, and the cell stack body 2 is cooled by liquid refrigerant flowing in the liquid-cooling heat sink.

In the present embodiment, when the thermostat 7 is disposed on the lower surface of the lower frame body 61, the thermostat accommodating portion 64 is provided in a recessed manner on the lower surface of the lower frame body 61, and the thermostat 7 is disposed in the thermostat accommodating portion 64. Thus, the length in the up-down direction of the battery module 1 can be shortened.

As described above, according to the battery module 1 of the present embodiment, since the lower frame 6 is fixed to the module supporting structure for supporting the battery module 1, even when the load in the cell stacking direction of the battery module 1 increases due to the expansion of the cell 21 caused by the temperature change and the aging deterioration, and accordingly the end plate 3 moves, the stress transfer to the module supporting structure can be avoided.

In addition, since the lower frame 6 is close to the lower surface of the cell stack body 2, it can also function as a heat radiating member that radiates heat of the cell stack body 2.

Further, since the fixing portions 62 of the lower frame 6 are disposed at the overlapping positions in the left-right direction with the left end plate portion 32L and the right end plate portion 32R having a smaller width in the front-rear direction, the length of the lower frame 6 provided with the fixing portions 62 can be shortened, and the length in the front-rear direction of the battery module 1 can be shortened.

In addition, since the lower frame 6 is provided with the guide portions 63 protruding upward from both left and right ends of the lower frame body 61 and extending in the front-rear direction, the deviation in the left-right direction is regulated by the guide portions 63 when the cell stack body 2 vibrates.

In addition, since the thermostat 7 is disposed below the lower frame 6, the temperature of the cell stack body 2 can be controlled by the thermostat 7.

Further, since the lower frame 6 is provided with the thermostat accommodating portion 64 recessed on the lower surface of the lower frame body 61 and the thermostat 7 is disposed in the thermostat accommodating portion 64, the length in the up-down direction of the battery module 1 can be shortened.

In addition, since the cell stack body 2 and the lower frame 6 are sandwiched between the upper flange portion 53 and the lower flange portion 54 of the right side frame 5R and the left side frame 5L, the relative position variation in the up-down direction is regulated even when the load is applied to the lower frame 6 in the up-down direction. For example, since the lower frame 6 is fastened to the right side frame 5R and the left side frame 5L, the distance between the upper flange portion 53 of the right side frame 5R and the left side frame 5L and the lower frame 6 is kept constant even when the load pushing up the lower frame 6 is applied. For this reason, the load applied to the terminal of each cell 21 and the busbar for connecting the cells 21 to each other is reduced.

In addition, since the upper flange portion 53 has elasticity, when the right side frame SR and the left side frame 5L are easily attached in the left-right direction due to the elastic deformation of the upper flange portion 53.

Further, since the fastening portions 54a provided in the lower flange portion 54 of the right side frame 5R are the leftwardly opened notch portion and the fastening portions 54a provided in the lower flange portion 54 of the left side frame 5L are the rightwardly opened notch portion, the right side frame 5R and the left side frame 5L can be mounted in the left-right direction in the state where the bolt B2 are temporarily fixed to the lower frame 6.

### Second Embodiment

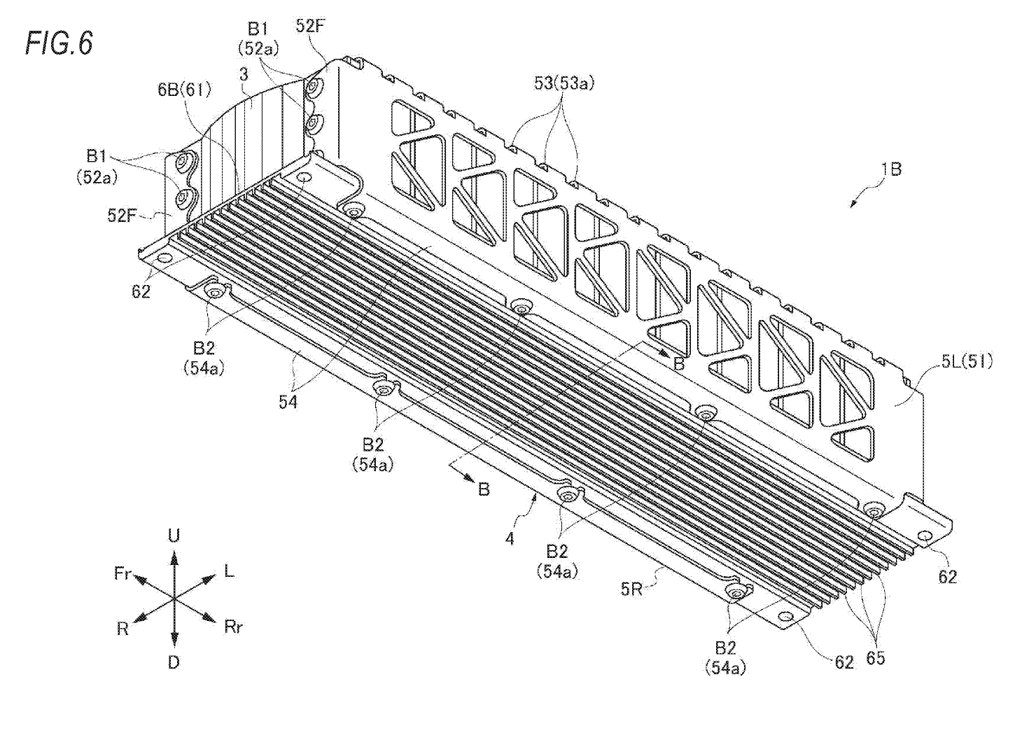

A battery module according to a second embodiment of the present invention will be described below with reference to FIGS. 6 to 10. However, only the differences from the first embodiment will be described, and the configurations common to the first embodiment will be denoted by the same reference numerals as in the first embodiment, so that the description of the first embodiment will be cited.

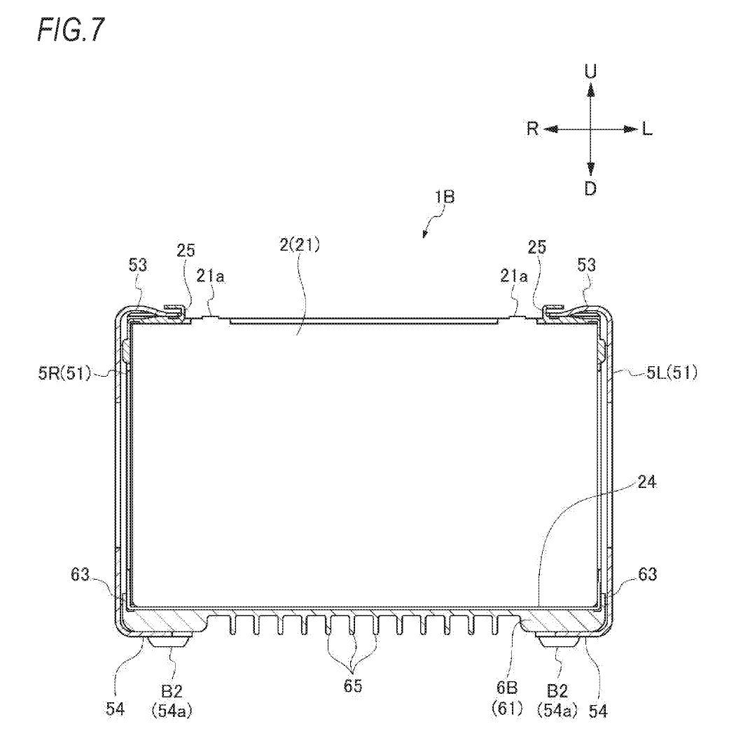

As illustrated in FIGS. 6 and 7, a battery module 1B according to the second embodiment differs from that of the first embodiment in that a lower frame 6B includes a plurality of fins 65 protruding downward from a lower surface of a lower frame body 61. For example, as illustrated in FIGS. 6 and 7, the plurality of fins 65 extend in a front-rear direction (aluminum extrusion direction at the time of molding) and are arranged in parallel in a left-right direction with a predetermined interval. According to such a battery module 1B, heat of the cell stack body 2 can be efficiently radiated through the lower frame body 61 and the plurality of fins 65. The fins 65 illustrated in FIGS. 6 and 7 are used for air cooling, but may be used for liquid cooling.

### Third Embodiment

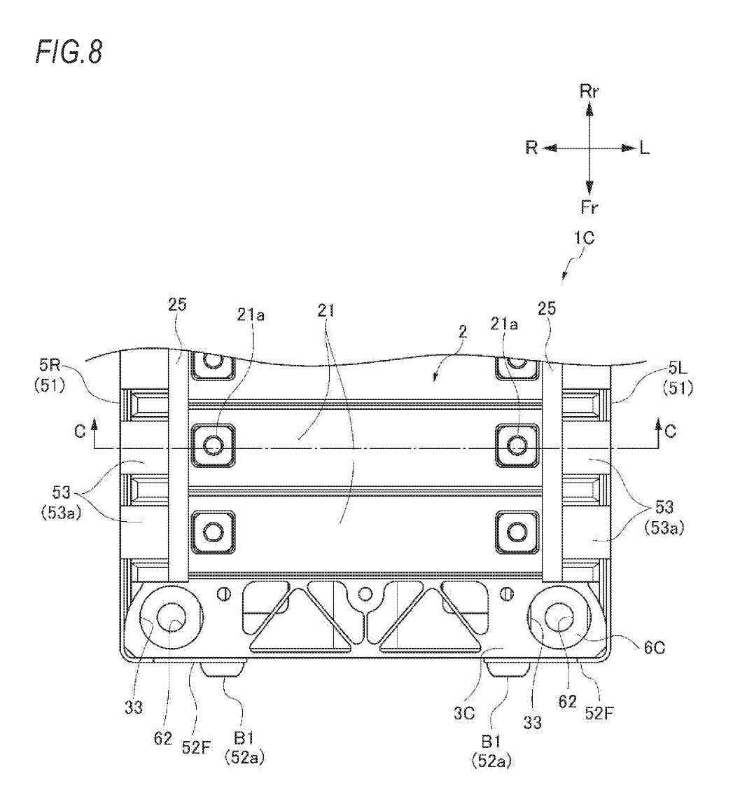

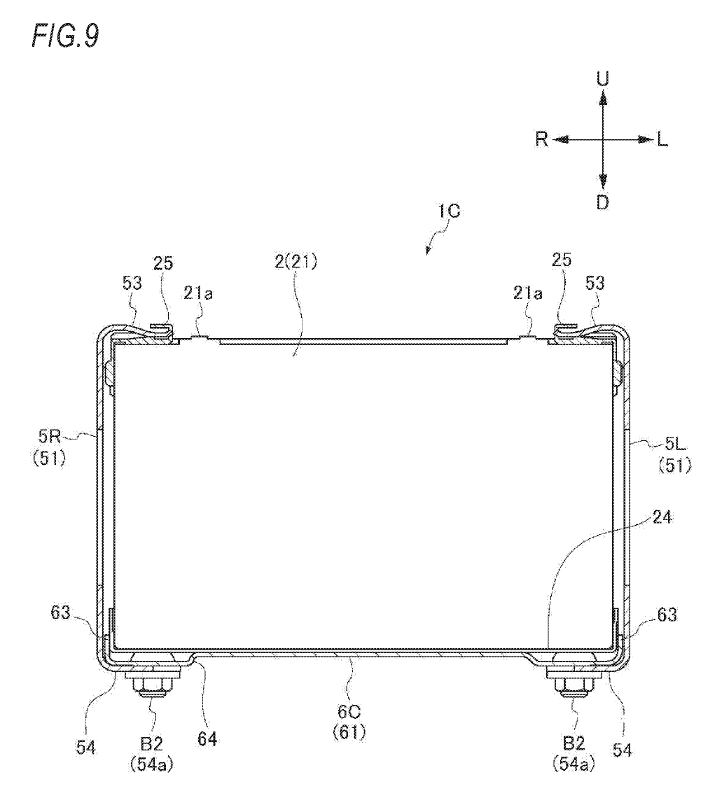

As illustrated in FIGS. 8 and 9, a battery module 1C according to a third embodiment differs from the above embodiments in that a pair of end plates 3C include hollow portions 33 penetrating in an up-down direction at least at left and right ends and fixing portions 62 of a lower frame 6C are disposed at overlapping positions with the hollow portions 33 of the end plate 3C when viewed in the up-down direction and in that the lower frame 6C is formed by press working of a metal plate. According to such a battery module 1C, since the fixing portions 62 are fixed through the hollow portions 33 of the end plate 3C, it is not necessary to lengthen the lower frame 6C in order to provide the fixing portions 62, and the length in the front-rear direction of the battery module 1C can be shortened. In addition, since the lower frame 6C is a press-worked product formed by the press working of the metal plate, cost reduction can be achieved.

### Fourth Embodiment

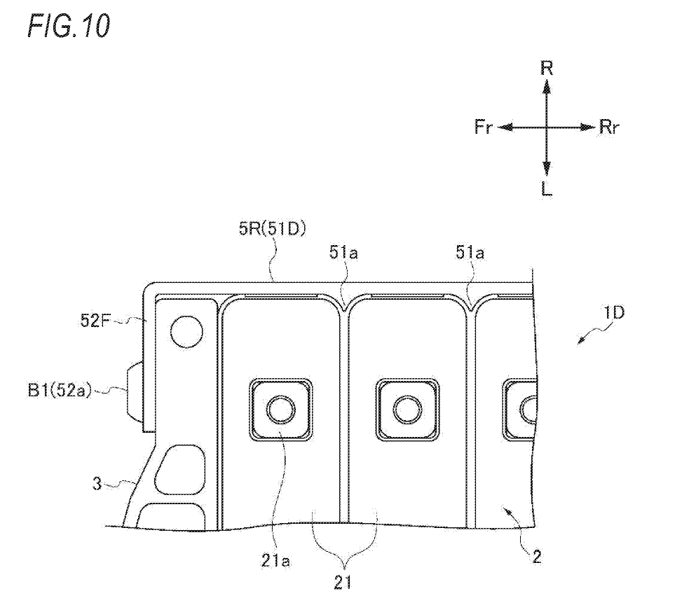

As illustrated in FIG. 10, a battery module ID according to a fourth embodiment differs from that of the first embodiment in that a side frame body 51D of a right side frame SR and a left side frame 5L includes a plurality of projections 51a extending in an up-down direction between cells 21 adjacent to each other. For example, as illustrated in FIG. 10, the projection 51a has a shape conforming to a shape of a corner of the cells 21 adjacent to each other, and is engaged with the cell 21 in the front-rear direction. According to the battery module 1D of the fourth embodiment, vibration in the front-rear direction of the cell 21 can be prevented by the plurality of projections 51a provided in the side frame body 51 of the right side frame 5R and the left side frame 5L.

It is noted that the present invention is not limited to the above-described embodiments, but can be appropriately modified and improved.

1. A battery module comprising:
a cell stack body that is constituted by a plurality of cells stacked in a front-rear direction and includes a front s face, a rear surface, a left surface, a right surface, an upper surface, and a lower surface;
a pair of end plates that are disposed on the front surface and the rear surface of the cell stack body; and
a fastening frame that connects the pair of end plates, wherein
the fastening frame includes:
a right side frame disposed on the right surface of the cell stack body;
a left side frame disposed on the left surface of the cell stack body; and
a lower frame disposed on the lower surface of the cell stack body,
the right side frame and the left side frame each includes a lower flange portion extending in a direction coming closer to each other along the surface of the cell stack body,
the lower frame is disposed between the lower surface of the cell stack body and the lower flange portions of the left side frame and the right side frame, and
the lower frame includes fixing portions that are fixed to a structure for supporting the battery module.

2. The battery module according to claim 1, wherein
the pair of end plates each includes:
a left end plate portion;
a right end plate portion, and
a central end plate portion interposed between the left end plate portion and the right end plate portion in a left-right direction,
a width of the central end plate portion in the front-rear direction is larger than a width of the left end plate portion and the right end plate portion in the front-rear direction, and
the fixing portions are disposed at overlapping positions with the left end plate portion and the right end plate portion in the left-right direction.

3. The battery module according to claim 1, wherein
the pair of end plates each includes a hollow portion that penetrates in an up-down direction, and
the fixing portions are disposed at overlapping positions with the hollow portions as viewed in the up-down direction.

4. The battery module according to claim 1, wherein
the lower frame includes:
a lower frame body extending along the lower surface of the cell stack body; and
guide portions protruding upward from left and right ends of the lower frame body and extending in the front-rear direction.

5. The battery module according to claim 1, wherein
the lower frame includes:
the lower frame body extending along the lower surface of the cell stack body; and
a fin protruding downward from a rear surface of the lower frame body.

6. The battery module according to claim 1, wherein
a thermostat is disposed below the lower frame.

7. The battery module according to claim 6, wherein
the lower frame includes:
a lower flame body extending along the lower surface of the cell stack body; and
a thermostat accommodating portion recessed on a rear surface of the lower frame body, and
the thermostat is disposed in the thermostat accommodating portion.

8. The battery module according to claim 1, wherein
the right side frame and the left side frame each includes an upper flange portion extending in a direction coming closer to each other along the upper surface of the cell stack body, and
the cell stack body and the lower frame are sandwiched by the upper flange portions of the right side frame and the left side frame and the lower flange portions of the right side frame and the left side frame.

9. The battery module according to claim 8, wherein
the upper flange portions have elasticity.

10. The battery module according to claim 1, wherein
the right side frame includes a side frame body extending along the right surface of the cell stack body,
the left side frame includes a side frame body extending along the left surface of the cell stack body, and
the side frame bodies of the right side frame and the left side frame each is provided with a projection extending in the up-down direction between the cells adjacent to each other.

11. The battery module according to claim 1, wherein
the lower flange portions of the right side frame and the left side frame each is provided with a fastening portion for fastening the lower frame with a bolt,
the fastening portion provided in the lower flange portion of the right side frame is a leftwardly opened notch portion, and
the fastening portion provided in the lower flange portion of the left side frame is a rightwardly opened notch portion.
